(19) United States
(12) Patent Application Publication
(10) Pub. No.: US 2017/0248699 A1
(43) Pub. Date: Aug. 31, 2017

(54) VISUALIZATION SYSTEM FOR MONITORED SPACE

(71) Applicant: Carrier Corporation, Jupiter, FL (US)

(72) Inventors: Hui Fang, Shanghai (CN); Peter R. Harris, West Hartford, CT (US); Jie Xi, Shanghai (CN)

(21) Appl. No.: 15/426,433

(22) Filed: Feb. 7, 2017

Related U.S. Application Data
(60) Provisional application No. 62/300,444, filed on Feb. 26, 2016.

(51) Int. Cl. G01S 17/89; G06F 3/0481; G01S 7/51; G06F 3/0484

(52) U.S. Cl. CPC G01S 17/89; G06F 3/04847; G06F 3/0481; G01S 7/51

(57) ABSTRACT

Visualization systems and methods for providing a visualization of a monitored space are provided. The visualization system includes a detector unit configured to obtain acquired data related to the monitored space, a processing device configured to store predefined information and process the acquired data, and a display device configured to display a user interface including the predefined information and the acquired data. The processing device is configured to receive the acquired data, process the acquired data with the predefined information, detect the presence of an anomaly, and generate a visualization of the anomaly and its evolution to be displayed on the display device.

### CROSS-REFERENCE TO RELATED APPLICATIONS

The present application claims priority from U.S. Provisional Patent Application No. 62/300,444, filed Feb. 26, 2016. The contents of the priority application are hereby incorporated by reference in their entirety.

### BACKGROUND

The subject matter disclosed herein generally relates to visualization systems and, more particularly, to visualization systems for monitored spaces and anomalies present therein.

Smoke detection is important for awareness of fire in its early stages. Conventional point smoke detectors are installed on the ceiling of a room and signal an alarm if smoke of a sufficient density (obscuration level) enters the detector. This configuration is effective in rooms of small size, where smoke transport dynamics play a more limited role in determining the time to alarm. In a large room, however (e.g., a lobby, atrium, or warehouse), the smoke transport time to the detector is relatively long, and extends the time during which the existence or potential existence of a fire is undetected. To address the problem of longer smoke transport time, more smoke detectors can be installed in the space, but this increases the cost of the detection system. As with point detectors, a large room with beam detectors would also require multiple units to obtain acceptable coverage, again providing for a costly detection system.

Additionally, conventional point and beam smoke detectors provide crude hazard position information, such as the approximate location of the alarming detector, which is not necessarily correlated to a real-time hazard position and evolution thereof. Information on the formation and propagation of smoke plumes, for example, is not available.

### SUMMARY

According to one embodiment, a visualization system for providing a visualization of a monitored space is provided. The visualization system includes a detector unit configured to obtain acquired data related to the monitored space, a processing device configured to store predefined information and process the acquired data, and a display device configured to display a user interface including the predefined information and the acquired data. The processing device is configured to receive the acquired data, process the acquired data with the predefined information, detect the presence of an anomaly, and generate a visualization of the anomaly and its evolution to be displayed on the display device.

In addition to one or more of the features described above, or as an alternative, further embodiments of the visualization system may include that the detector unit is a LIDAR detector unit.

In addition to one or more of the features described above, or as an alternative, further embodiments of the visualization system may include that the detector unit is configured to obtain a 360° , two-dimensional data set representative of the monitored space.

In addition to one or more of the features described above, or as an alternative, further embodiments of the visualization system may include that the processing device is configured within the detector unit.

In addition to one or more of the features described above, or as an alternative, further embodiments of the visualization system may include that the processing device and the display device are configured within a remote device separate from the detector unit.

In addition to one or more of the features described above, or as an alternative, further embodiments of the visualization system may include that the user interface includes a visualization component and an interface component.

In addition to one or more of the features described above, or as an alternative, further embodiments of the visualization system may include that the visualization component includes a first window and a second window, the first window being configured to display a visual representation of the acquired data and the second window being configured to display the visualization of the anomaly.

In addition to one or more of the features described above, or as an alternative, further embodiments of the visualization system may include that the interface component includes interactive user fields and interactive program features.

In addition to one or more of the features described above, or as an alternative, further embodiments of the visualization system may include that the interactive user fields include display parameter settings and detection parameter settings.

In addition to one or more of the features described above, or as an alternative, further embodiments of the visualization system may include that the visualization of the anomaly includes notification information.

In addition to one or more of the features described above, or as an alternative, further embodiments of the visualization system may include a memory configured to store the predefined information and the acquired data, wherein the processing device is configured to provide playback of the stored information and data.

According to another embodiment, a method of providing a visualization of a monitored space is provided. The method includes receiving, at a processing device, acquired data from a detector unit, processing the acquired data with predefined information, detecting the presence of an anomaly, generating a user interface configured to display information and receive user input, and generating a visualization of the anomaly and its evolution to be displayed within the user interface on a display device.

In addition to one or more of the features described above, or as an alternative, further embodiments of the method may include that the detector unit is a LIDAR detector unit.

In addition to one or more of the features described above, or as an alternative, further embodiments of the method may include that the detector unit is configured to obtain a 360° , two-dimensional data set representative of the monitored space.

In addition to one or more of the features described above, or as an alternative, further embodiments of the method may include that the processing device is configured within the detector unit.

In addition to one or more of the features described above, or as an alternative, further embodiments of the method may include that the processing device and the display device are configured within a remote device separate from the detector unit.

In addition to one or more of the features described above, or as an alternative, further embodiments of the method may include that the user interface includes a visualization component and an interface component.

In addition to one or more of the features described above, or as an alternative, further embodiments of the method may include that the visualization component includes a first window and a second window, the first window configured to display a visual representation of the acquired data and the second window configured to display the visualization of the anomaly.

In addition to one or more of the features described above, or as an alternative, further embodiments of the method may include that the interface component includes interactive user fields and interactive program features.

In addition to one or more of the features described above, or as an alternative, further embodiments of the method may include that the interactive user fields includes display parameter settings and detection parameter settings.

In addition to one or more of the features described above, or as an alternative, further embodiments of the method may include generating notification information regarding the detected anomaly and displaying the notification information in the user interface.

Technical effects of embodiments of the present disclosure include a visualization system configured to provide real-time monitoring and visual information regarding an anomaly, such as a smoke plume, in a monitored space.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic illustration of an exemplary environment incorporating one or more detector units;

FIG. 1B illustrates a block diagram of a computer system for use in practicing the teachings herein;

FIG. 2 is a schematic illustration of a user interface of a visualization system in accordance with an embodiment of the present disclosure; and

FIG. 3 is a flow process of a visualization system in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

In some embodiments, a scanning LIDAR (Light Detection and Ranging, typically utilizing an eye-safe laser as a light source) device may be used to actively look for smoke plumes in, e.g., large rooms. In some embodiments, a laser beam transmission unit and a reception unit may be located in a common device and the range to an object may be determined by measuring the time delay between transmission of a laser pulse and reception of a reflected or scattered signal. A motor may rotate a mirror, or a non-mechanical liquid-crystal-based beam steering device may be used to transmit laser pulses and collect the resulting scattered light. The laser beam may be rotated to scan a two-dimensional (2D) plane surrounding the unit, with a wide field of view, e.g., 180 degrees, 360 degrees, etc.

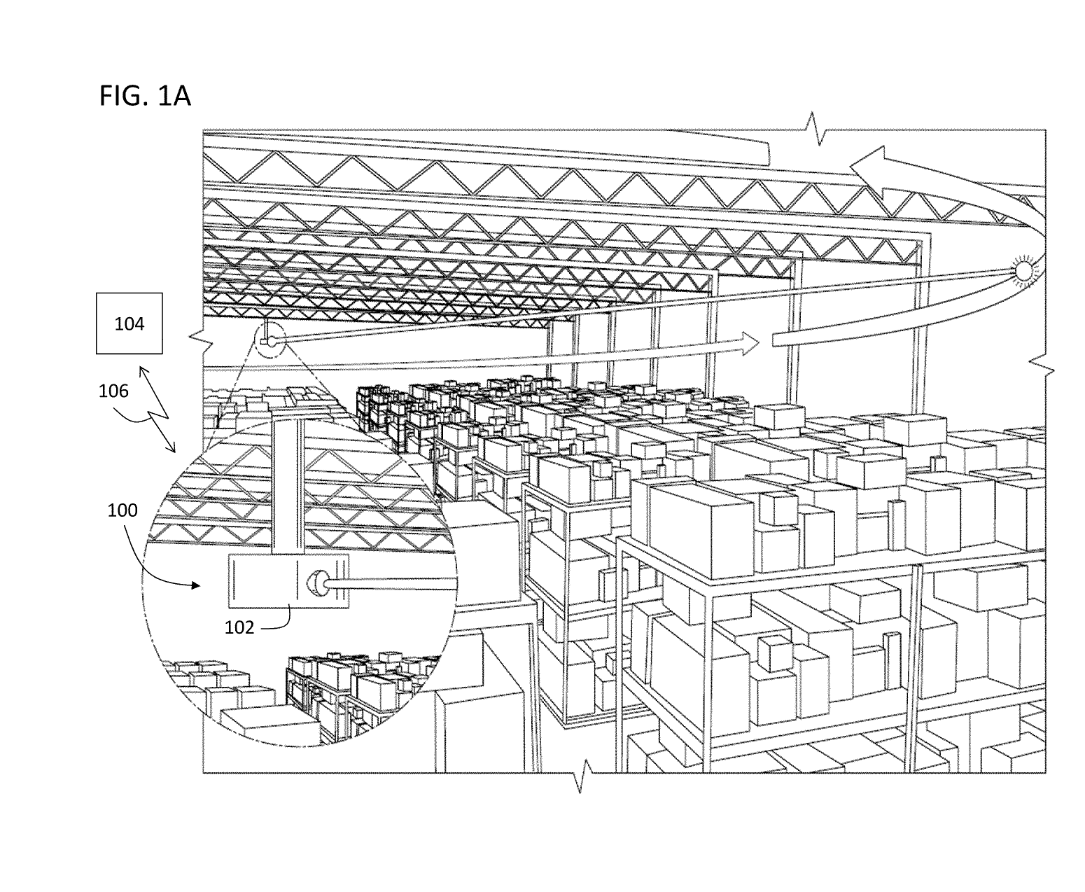

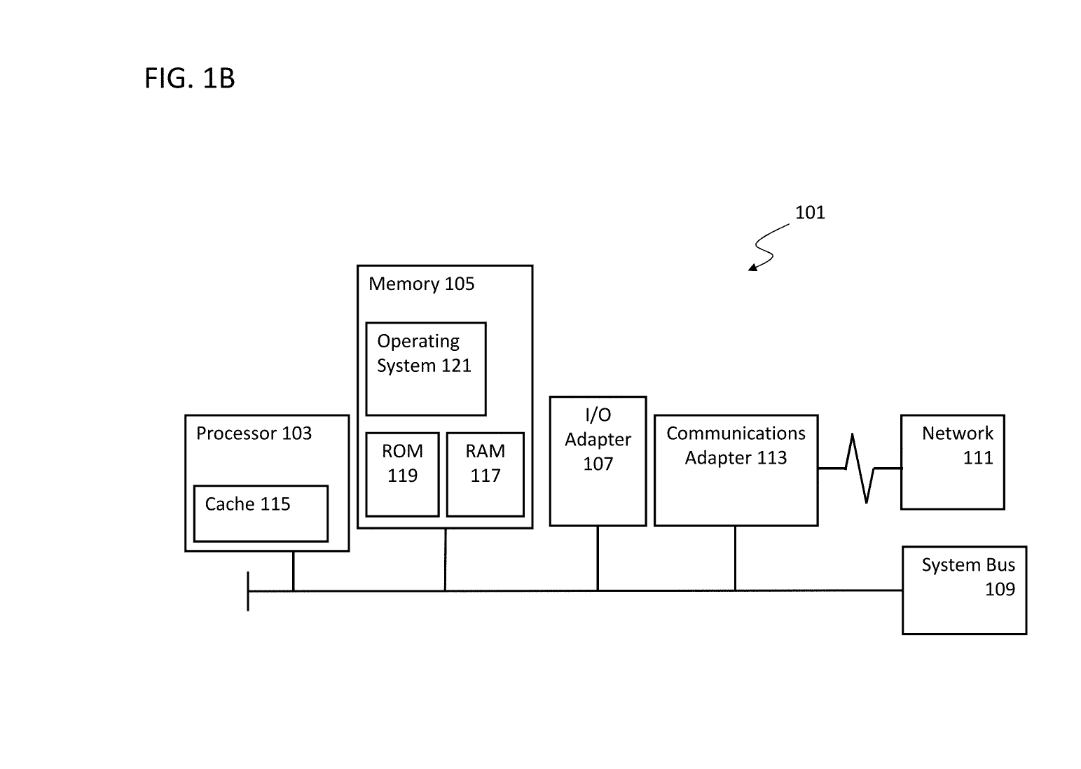

Various embodiments provided herein may incorporate LIDAR scanning for smoke detection as illustrated in FIG. 1A. A detector unit 100 may include a rotating detector head 102 that may rotate and emit pulses of light and measure a reflection of the emitted light to measure distances to reflective objects. Those of skill in the art will appreciate that scattering may also serve as a basis for detecting features that are in proximity to the detector unit 100. The detector unit 100 may be in communication with a processing device 104, such as a computer, server, microprocessor, etc. The detector unit 100 may communicate with the processing device 104 by wired or wireless communications 106, as known in the art. The processing device 104 may include a display or other type of monitor and/or user interface.

Detection of smoke by the detector unit 100 and/or the remote unit 104 may rely on an analysis of a size and shape of a smoke plume as a function of time. As such an ability to compare data collected from a prior rotation of the detector unit 100 and/or detector head 102 while in the same position or orientation may be carried out.

Turning now to FIG. 1B, a block diagram of a computing system 101 (hereafter “system 101”) for use in practicing the embodiments described herein is shown. The system 101 may be configured as the detector unit 104 and/or the remote unit 104, wherein in some embodiments, some of the functionality may be shared and/or split between the two different devices. The methods and processed described herein can be implemented in hardware, software (e.g., firmware), or a combination thereof. In an exemplary embodiment, the methods described herein may be implemented in hardware, and may be part of the microprocessor of a special or general-purpose digital computing system.

In the non-limiting embodiment of FIG. 1B, in terms of hardware architecture, the system 101 includes a processor 103. The system 101 also includes memory 105 coupled to the processor 103, and one or more input and/or output (I/O) adapters 107, that may be communicatively coupled via a local system bus 109. The memory 105 may be operatively coupled to one or more internal or external memory devices accessed through a network 111. A communications adapter 113 may operatively connect the system 101 to the network 111 or may enable direct communication between the system 101 and other devices. For example, in some embodiments, the communications adapter 113 may enable communication between the detector unit 100 and the processing device 104, and/or other device(s).

The processor 103 may be a hardware device for executing hardware instructions or software that may be stored in a non-transitory computer-readable memory (e.g., memory 105) or provided from an external source through the network 111. The processor 103 can be any custom made or commercially available processor, a central processing unit (CPU), a plurality of CPUs, an auxiliary processor among several other processors associated with the system 101, a semiconductor based microprocessor (in the form of a microchip or chip set), a macroprocessor, or generally any device for executing instructions. The processor 103 can include a memory cache 115. The processor 103 may be configured to perform sensory processing.

The memory 105 can include random access memory (RAM) 117 and read only memory (ROM) 119. The RAM 117 can be any one or combination of volatile memory elements (e.g., DRAM, SRAM, SDRAM, etc.). The ROM 119 can include any one or more non-volatile memory elements (e.g., erasable programmable read only memory (EPROM), flash memory, electronically erasable programmable read only memory (EEPROM), programmable read only memory (PROM), tape, compact disc read only memory (CD-ROM), disk, cartridge, cassette or the like, etc.). Moreover, the memory 105 may incorporate electronic, magnetic, optical, and/or other types of non-transitory computer-readable storage media. As will be appreciated by those of skill in the art, the memory 105 can have a distributed architecture, where various components are situated remote from one another, but can be accessed by the processor 103.

The instructions in the memory 105 may include one or more separate programs, each of which comprises an ordered listing of computer-executable instructions for implementing logical functions. In the example of FIG. 1C, the instructions in the memory 105 may include a suitable operating system 121. The operating system 121 can control the execution of other computer programs and provide scheduling, input-output control, file and data management, memory/storage management, communication control, and related services. For example, if the system 101 represents a system of the processing device 104, the operating system 121 may be an operating system for a computer that includes the processor 103 and other associated components as shown and described in system 101.

The I/O adapter 107 can be, for example but not limited to, one or more buses or other wired or wireless connections, as is known in the art. The I/O adapter 107 may have additional elements, which are omitted for simplicity, such as controllers, buffers (caches), drivers, repeaters, and receivers, to enable communications. For example, the I/O adapter 107 may be operably and/or communicably connected to lights and/or sensors of the rotating detector head 102.

As noted, the system 101 may include a communications adapter 113 for coupling to the network 111 or coupling the system 101 to a remote and/or local device, such as a smartphone, tablet, local computer, etc. As such, in some embodiments, the communications adapter 113 may be a wireless connection device that may enable wireless communication. For example, in some embodiments, the communications adapter 113 may enable Bluetooth® communication and/or NFC communications. Further, in some embodiments, the communications adapter 113 may enable Wi-Fi or other internet communications. Further, in some embodiments, wired communication may be enabled through the communications adapter 113. As will be appreciated by those of skill in the art, various combinations of communications protocols may be used without departing from the scope of the present disclosure.

The network 111 can be an IP-based network for communication between system 101 and any external device(s). The network 111 enables transmissions of data between the system 101 and external systems. In a non-limiting embodiment, the network 111 can be a managed IP network administered by a service provider. The network 111 may be implemented in a wireless fashion, e.g., using wireless protocols and technologies, such as WiFi, WiMax, etc. The network 111 can also be a packet-switched network such as a local area network, wide area network, metropolitan area network, Internet network, or other similar type of network environment. The network 111 may be a fixed wireless network, a wireless local area network (LAN), a wireless wide area network (WAN) a personal area network (PAN), a virtual private network (VPN), intranet or other suitable network system.

In some embodiments, the instructions in the memory 105 may further include a basic input output system (BIOS) (omitted for simplicity). The BIOS is a set of essential routines that initialize and test hardware at startup, start the operating system 121, and support the transfer of data among the operatively connected hardware devices. The BIOS may be stored in the ROM 119 so that the BIOS can be executed when the system 101 is activated. When the system 101 is in operation, the processor 103 may be configured to execute instructions stored within the memory 105, to communicate data to and from the memory 105 and/or processing devices through the network 111, and to generally control operations of the system 101 pursuant to the instructions.

The detection unit 100, the processing device 104, and/or system 101, may be used to generate a graphical display and/or user interface that may present information and/or visualization to a user of the system.

As noted, a LIDAR for smoke detection system carries out 180° or 360° 2D horizontal scanning of room, e.g., using detector head 102. The scanning rate depends on motor speed, which may be housed within the detector head 102. After a complete rotation, LIDAR data may be quickly transferred from the detection system 100 to the processing device 104, e.g., a PC. After the processing device 104 receives the data, range and angular information for each data point can be calculated and mapped to a coordinate system of a room that is monitored by the detection unit 100. Accordingly, real-time visualization of the room and a smoke plume can be achieved. The progression of the smoke plume may be updated at the same rate as the LIDAR scanning rate. Based on smoke detection results, smoke plume region information can be extracted and visualized on a display device. Further, information like position, size, and evolution speed can be computed and displayed. Moreover, with a user interface, a select subset of smoke detection algorithm parameters can be easily changed via visualization software to evaluate the effect on detector performance and gain intuitive insight into the operation of a detector.

LIDAR for smoke detection enables sampling a full 2D plane within a protected space, as shown and described above, which significantly reduces smoke transport times for detection. Beyond vastly increased sampling regions, LIDAR for smoke detection, using systems as described above, may generate significant amounts of data including, but not limited to, detailed information on smoke plume position, plume size, and/or plume shape evolution (e.g., over time). As provided herein, systems, methods, tools, and processes are provided for visualization of data generated from a smoke detection system. Such visualization systems may ensure the collected data is useful for both fire protection professionals as well as for the education of building owners. For example, the visualization systems as provided herein may be useful for effective suppression and/or rescue efforts and post-fire investigative efforts.

As described above, 90° , 180° , 270° , 360° , etc. 2D horizontal scanning and data acquisition may be obtained using a LIDAR smoke detection system. Collected data may be transferred from the detector to a computer (e.g., processing device 104) for processing in real-time or near real-time, e.g., data of one revolution or rotation of the detector.

The processing device may include predefined information regarding a space to be monitored (e.g., a room). The processing device may generate or define a coordinate system for the monitored space. The coordinate system may be based on the position of a detector unit as an origin and each feature or structure in the monitored space. Because the detector unit may be a LIDAR system, with a 2D, 360 degree imaging, the coordinates may include distance and angular information.

Accordingly, the predefined information may include data points that define the monitored space in a static or known condition (e.g., when no smoke or other anomalies are present in the space). For example, the predefined information may include a data set that represents the collected data from a detector unit under the known condition. In one non-limiting example, the predefined information may include a data set that represents walls of the monitored space, or in the case of a storage facility, may include information including the walls, shelves, boxes, containers, etc. In the case of an office or other space that may be occupied by persons, the predefined information may include a data set that represents desks, doorways, chairs, etc. The predefined information may be a data set including range and angular information for the features and/or structures within the monitored space.

When a smoke plume, or other anomaly, is present in the monitored space, the detector unit may acquire data representative of the smoke plume or anomaly. The acquired data may include information related to the coordinate system or may be assigned or converted to translated data that converts the acquired data into the coordinate system. The acquired data may be used to provide a visualization of the location, size, and evolution of the smoke plume or anomaly.

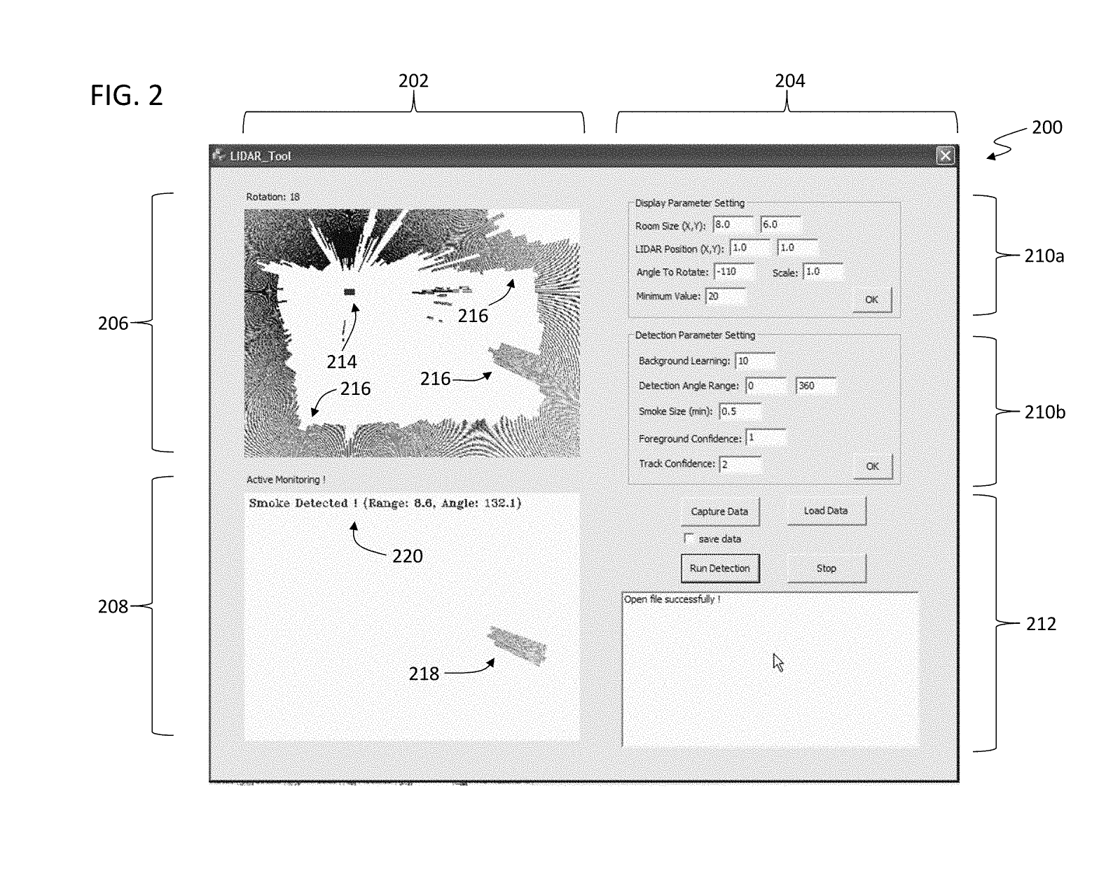

Turning now to FIG. 2, the above predefined data and acquired data may be used to generate a visualization that may be displayed on a display device or other type of screen or monitor. FIG. 2 is a schematic illustration of a user interface 200 that may be used in connection with the detector unit to provide a visualization of the acquired data. The user interface 200 may include a visualization component 202 and an interface component 204.

The visualization component 202 may include one or more display windows for providing visualization as described herein. For example, as shown, the visualization component 202 may include a first window 206 and a second window 208. The first window 206 may be a display or visualization of a real-time collected data set including acquired data. The first window 206 may thus show all data collected by a detector unit, including the static, predefined information, plus any additional information that may be generated by the presence of a smoke plume or other anomaly. The second window 208 may be a display or visualization of only the anomaly. That is, the second window 208 may display a visualization of the acquired data with the predefined information subtracted therefrom. The subtraction can be achieved by well-known background modeling and subtraction techniques, such as a Gaussian Mixture Model. Furthermore, the detection algorithm will determine whether the subtracted data is an anomaly or not. If it is determined that anomaly exists, the subtracted data will be displayed in the second window 208. As such, a visualization and/or representation may be provided to show real-time location, size, shape, and/or evolution of an anomaly, such as a smoke plume.

The interface component 204 may include interactive user fields including display parameter settings 210a and detection parameter settings 210b. The interface component 204 may further provide interactive program features 212 which may include buttons or other options for capturing data, running detection, and/or a log display.

The display parameter settings 206a may be configured to enable a user to input particular parameters and/or information that may be used to aid in providing an accurate visualization. For example, the display parameter settings 206a may include inputs and/or information regarding room size, position of a detector unit, rotation angle of the detector unit, minimum values, etc. The display parameter settings 206a may be used to provide the predefined information into the system.

The detection parameter settings 206b may be configured to enable a user to input parameters regarding detection and criteria for detection. For example, detection parameter settings 206b may include inputs and/or information regarding background learning, detection angle rangers, minimum detectable anomaly size, foreground confidence, track confidence, etc.

The interactive program features 212 may include the ability to run data capture and/or detection with an associated detector unit. Further, the interactive program features 212 may enable saving of data, loading of historical data, or other features. Moreover, the interactive program features 212 may include a display window for providing a text-based or other visual log of operations of the system.

Thus, in use, after the processing device receives the acquired data from the detector unit, range and angular information for each data point can be calculated and mapped to the coordinate system of the monitored space. This is shown, for example, in the first window 206. Based on smoke detection results, smoke plume region information can be extracted and visualized and information like position, size and evolution speed can be computed, as shown in the second window 208. A select subset of smoke detection algorithm parameters can be easily changed via the visualization software to evaluate the effect on detector performance and gain intuitive insight into the detector's operation.

As shown, the first window 206 includes visualized information regarding a monitored space. For example, as shown, a location or position of a detector unit 214 is shown. Further, acquired data 216 may be visually shown, including predefined data and anomaly data—that is, the acquired data 216 includes all data points acquired by a detector unit a particular time. The acquired data 216 may not be, necessarily, visually indicative of an anomaly in the room (e.g., a smoke plume). Accordingly, the visualization system, as provided herein, may operate an algorithm to subtract out the predefined information from the acquired data to extract out and enable visualization of an anomaly in the monitored space.

For example, as shown, the second window 208 may include a visualization of an anomaly 218. The visualization may be the result of subtracting the predefined information from the acquired data 216, shown in the first window 206. Accordingly, a user may easily view and understand the location, position, size, and, over time, the evolution of an anomaly, such as a smoke plume. Further, the second window 208 may include notification information 220, which may be generated as part of an algorithm operating on the acquired data 216. The notification information 220 may include a notice that an anomaly, such as smoke, is detected, and further may provide information regarding the location of the detected anomaly 218. Other information of the notification information may include size, growth rate, etc.

Accordingly, embodiments provided herein are directed to a visualization system that may enable localization and identification of anomalies within a monitored space. Specifically, an optical sensor, such as a LIDAR detector unit, may be used to generate raw data related to a monitored space, such as a mapping of the monitored space when no anomaly is present. Then, in real-time, the optical sensor may generate acquired data that may include information of an anomaly present in the monitored space, such as a smoke plume. From the raw data, the visualization system may be used to provide information to a user of the tool, including, but not limited to, position, size, growth, etc. of the anomaly.

Further, in accordance with some embodiments, the information and data used to generate and display the user interface 200 can be stored into or on memory or other storage (e.g., memory 105 of FIG. 1B). Accordingly, tracking and historical viewing of the information in the user interface 200 is provided in some embodiments. That is, the data collected by the visualization system may be recorded for later playback. As such, in accordance with some embodiments of the present disclosure, a video and/or visualization playback is enabled through the storage of data collected using the visualization system as provided herein. Such playback, in some embodiments, may be provided in an offline mode, wherein the playback is provided even if a sensor or other device or component of the system is not actively monitoring a space. Such feature may enable analysis after the fact and/or provide replayability and demonstration of real world data and/or events.

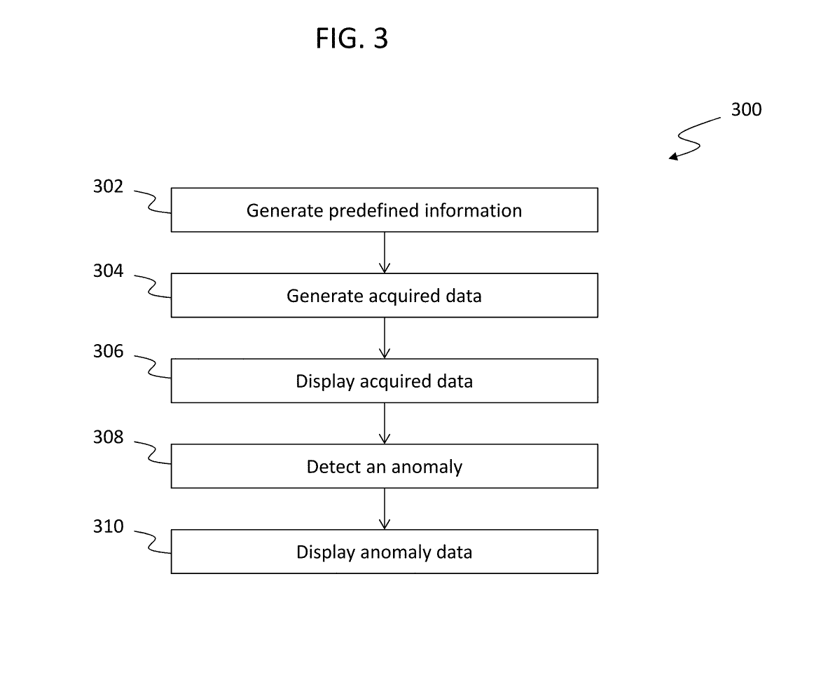

Turning now to FIG. 3, a flow process 300 in accordance with an embodiment of the present disclosure is shown. Flow process 300 may be performed on a system similar to that shown in FIGS. 1A and 1B, wherein the flow process 300 may be performed on one or more devices including, but not limited to, a detector unit located in a monitored space and a remote unit having a display.

As shown at block 302, a predefined information data set may be generated. The predefined information may be related to and/or representative of a static or known condition of a monitored space. For example, the predefined information may include data points and/or information related to all aspects of the monitored space that are present when no anomaly (e.g., smoke plume) is present. Thus, the predefined information includes a known data set. In one non-limiting embodiment, the predefined information data set includes data collected by a LIDAR system when no smoke or other anomalies are present in the monitored space, e.g., obtained during an initialization stage of a system. Such initial data collection may be referred to as background learning.

As shown at block 304, a detector unit may collect raw data to generate an acquired data set. The acquired data set may be a data set collected in real time by the detector unit. The acquired data set may be one full revolution, rotation, or scan as performed by the detector unit, depending in the configuration thereof. The acquired data may be sent to a device having a display.

As shown at block 306, the acquired data may be converted into displayable data such that the acquired data may be displayed on a display, screen, or in a window thereof. Thus, a user may have a visual representation presented on a display of the acquired data in real time or near real time.

As shown at block 308, detection of an anomaly may be performed. The detection may include generation of data related to the anomaly. For example, an algorithm may be used to process the acquired data to generate a data set that represents an anomaly within the monitored space. The algorithm may perform filtering and/or subtraction, using the predefined information to obtain information or data related to the anomaly, i.e., information or data related to anything that is not part of the predefined information. From the above information/data, the system may determine that an anomaly is present, such as a smoke plume.

As shown at block 310, the generated anomaly data may be displayed on the display, screen, or in a window thereof. The displayed anomaly data may provide a visualization of the anomaly, such as a smoke plume. The display may provide a representation of the location of the anomaly within the monitored space, the size and/or shape of the anomaly, and/or a growth and/or evolution of the anomaly. That is, because the anomaly data may be generated in real-time, a progression of the anomaly over time may be provided in the display. Further, the generated anomaly data and display thereof may further include notification information that includes information about the anomaly, such as notification of the presence of the anomaly and/or the position of the anomaly, or other pertinent and/or related information.

The flow process 300, or portions thereof, may be repeated to enable generation of a progression and/or evolution of an anomaly. As such, the process may be repeated with the data collected therein stored and used to generate a progression or evolution of an anomaly in the monitored space. That is, a first data set of the anomaly may be generated at a first time, and at a subsequent second time a second data set may be generated. The first and second data sets may be compared, filtered, and/or combined to generate a representation of a progression or evolution of the anomaly.

Advantageously, embodiments described herein provide, real-time visualization of a monitored space and an anomaly present therein can be achieved. The real-time visualization may be updated at the same rate as a scanning rate of a detector unit, such as a LIDAR detector that rotates to enable a 360 degree monitoring of a monitored space.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

For example, although described as a subtraction of the predefined information from the acquired data, other filtering operations may be performed to achieve similar visualization outputs. Further, as noted, the processing may be performed at the detector unit, on a processing device, and/or the processing may be shared between multiple components without departing from the scope of the present disclosure. For example, conversion of the raw collected data into a coordinate system may be performed at the detector unit and then the filtering and/or other operations may be performed at the processing device. Alternatively, the raw data may be live-streamed to the processing device for all processing to be carried out at the processing device. Further, other combinations of data processing may be used without departing from the scope of the present disclosure.

Further, although primarily described as a 360° field of view, those of skill in the art will appreciate that other fields of view may be used without departing from the scope of the present disclosure. For example, in some non-limiting embodiments, the field of view may be 90° , 180° , 270° , 360° , or any other desired angle or field of view.

Accordingly, the present disclosure is not to be seen as limited by the foregoing description, but is only limited by the scope of the appended claims.

What is claimed is:

1. A visualization system for providing a visualization of a monitored space, the visualization system comprising:
a detector unit configured to obtain acquired data related to the monitored space;
a processing device configured to store predefined information and process the acquired data; and
a display device configured to display a user interface including the predefined information and the acquired data,
wherein the processing device is configured to:
receive the acquired data;
process the acquired data with the predefined information;
detect the presence of an anomaly; and
generate a visualization of the anomaly and its evolution to be displayed on the display device.

2. The visualization system of claim 1, wherein the detector unit is a LIDAR detector unit.

3. The visualization system of claim 1, wherein the detector unit is configured to obtain a 360° , two-dimensional data set representative of the monitored space.

4. The visualization system of claim 1, wherein the processing device is configured within the detector unit.

5. The visualization system of claim 1, wherein the processing device and the display device are configured within a remote device separate from the detector unit.

6. The visualization system of claim 1, wherein the user interface includes a visualization component and an interface component.

7. The visualization system of claim 6, wherein the visualization component includes a first window and a second window, the first window configured to display a visual representation of the acquired data and the second window configured to display the visualization of the anomaly.

8. The visualization system of claim 6, wherein the interface component includes interactive user fields and interactive program features.

9. The visualization system of claim 8, wherein the interactive user fields includes display parameter settings and detection parameter settings.

10. The visualization system of claim 1, wherein the visualization of the anomaly includes notification information.

11. The visualization system of claim 1, further comprising a memory configured to store the predefined information and the acquired data, wherein the processing device is configured to provide playback of the stored information and data.

12. A method of providing a visualization of a monitored space, the method comprising:
receiving, at a processing device, acquired data from a detector unit;
processing the acquired data with predefined information;
detecting the presence of an anomaly;
generating a user interface configured to display information and receive user input; and
generating a visualization of the anomaly and its evolution to be displayed within the user interface on a display device.

13. The method of claim 11, wherein the detector unit is a LIDAR detector unit.

14. The method of claim 11, wherein the detector unit is configured to obtain a 360° , two-dimensional data set representative of the monitored space.

15. The method of claim 11, wherein the processing device is configured within the detector unit.

16. The method of claim 11, wherein the processing device and the display device are configured within a remote device separate from the detector unit.

17. The method of claim 11, wherein the user interface includes a visualization component and an interface component.

18. The method of claim 17, wherein the visualization component includes a first window and a second window, the first window configured to display a visual representation of the acquired data and the second window configured to display the visualization of the anomaly.

19. The method of claim 17, wherein the interface component includes interactive user fields and interactive program features.

20. The method of claim 19, wherein the interactive user fields includes display parameter settings and detection parameter settings.
